(19) United States
(12) Patent Application Publication
(10) Pub. No.: US 2006/0100047 A1
(43) Pub. Date: May 11, 2006

(54) Compliant snubber

(75) Inventors: Bruce A. Churchill, Groton, NY (US); Timothy J. Ledvina, Groton, NY (US); Laurence Parks, Waverly, NY (US)

Correspondence Address: BORGWARNER INC., 3850 HAMLIN ROAD, AUBURN HILLS, MI, 48326, US

(73) Assignee: BorgWarner Inc., Auburn Hills, MI (US)

(21) Appl. No.: 10/984,560

(22) Filed: Nov. 9, 2004

(51) Int. Cl. F16H 7/08; F16H 7/22

(52) U.S. Cl. 474/109; 474/101; 474/111

(57) ABSTRACT

A compliant snubber for a chain is disclosed. The snubber preferably includes an elastomeric body and metal bushings. The compliance feature allows the snubber to be located with a negative clearance to the back side of the chain without causing excessive surface loads that may result in excessive snubber surface wear, thereby improving the effectiveness of the snubber in the application. The compliant snubber has the added advantage of reducing the costs associated with manufacturing the snubber and assembling the snubber into a chain system.

### BACKGROUND OF THE INVENTION

1. Field of the Invention

The invention pertains to the field of chains. More particularly, the invention pertains to a snubber for eliminating strand resonance of chains.

2. Description of Related Art

A snubber is a device used to eliminate chain strand motion resulting from strand resonance. Snubbers prevent or limit chain vibration. In U.S. Pat. No. 4,193,314, TIMING CHAIN SNUBBER, issued Mar. 18, 1980 to Homer et al., the snubber contacts the inside surface of the chain to prevent inward movements. In U.S. Pat. No. 5,989,138, TENSIONER WITH ADJUSTABLE SNUBBER, issued Nov. 23, 1999 to Capucci, the snubber is combined with a chain tensioner and contacts the outside surface of the chain to prevent outward movements.

Previous snubber designs are typically made of an elastomeric surface bonded to a metal bracket. Two main problems have been found with the metal bracketed design. First, the performance of the prior art snubber is greatly impacted by the locational tolerance of the mounting holes. The effect is so great that some form of adjustment during assembly is often required to attain optimal performance. In U.S. Pat. No. 6,554,728, FASTENERLESS CHAIN SNUBBER, issued Apr. 29, 2003 to Young, Jr. et al., this problem is addressed and the snubber has no mounting holes. The snubber body is plastic but may contain a steel plate for reinforcement. The snubber has two arms by which it is mounted to two attachment channels formed by the chain housing.

The second problem with the prior art metal bracket design is that it does not effectively isolate the snubber from the chain system's case, and the vibrations of the chain strand are freely conducted to the vehicle.

There is a need in the art for a compliant snubber that requires no adjustments during assembly and effectively isolates chain vibrations from the rest of the vehicle.

### SUMMARY OF THE INVENTION

A compliant snubber for a chain is disclosed. The snubber preferably includes an elastomeric body and metal bushings. The compliance feature allows the snubber to be located with a negative clearance to the back side of the chain without causing excessive surface loads that may result in excessive snubber surface wear, thereby improving the effectiveness of the snubber in the application. The compliant snubber has the added advantage of reducing the costs associated with manufacturing the snubber and assembling the snubber into a chain system.

The compliant snubber for a chain includes a snubber body having a convex contact surface for contacting the chain and a compliance cavity located adjacent to the convex contact surface and extending through the snubber body. The compliance cavity is preferably oblong in shape. In one embodiment of the present invention, a leaf spring is located in the compliance cavity to exert a force in a direction of the contact surface. The snubber body is preferably made of an elastomer. In some embodiments, the snubber body is made of a first elastomer and the contact surface is made of a second elastomer, where the second elastomer is harder than the first elastomer. In a preferred embodiment, the snubber further includes a mounting feature for mounting the snubber to an application case. In another preferred embodiment, the mounting feature includes at least two holes through the snubber body, where the compliance cavity is located between the holes and the contact surface. In another embodiment of the present invention, the snubber body is made of a first material and the compliance cavity is filled with a second material having a lower spring rate than the first material. In yet another preferred embodiment, the snubber further includes a plurality of opposing teeth extending from the snubber body into the compliance cavity, and the teeth are preferably formed along the length of the compliance cavity and offset such that the snubber has a variable spring rate.

### BRIEF DESCRIPTION OF THE DRAWINGS

FIG. 1 shows a profile of a first embodiment of the present invention.

FIG. 2 shows a cross section of the embodiment of FIG. 1 along line 2-2.

FIG. 3 shows a profile of a second embodiment of the present invention with a leaf spring.

FIG. 4 shows a cross section of the embodiment of FIG. 3 along line 4-4.

FIG. 5 shows a profile of a third embodiment of the present invention with a contact surface made of a second elastomer.

FIG. 6 shows a cross section of the embodiment of FIG. 5 along line 6-6.

FIG. 7 shows a profile of a fourth embodiment of the present invention having a compliance cavity with teeth.

FIG. 8 shows a chain contacting the snubber of FIG. 7.

### DETAILED DESCRIPTION OF THE INVENTION

A snubber of the present invention prevents the lateral motion that accompanies the resonant condition. The compliant contact surface of a snubber of the present invention allows the snubber to be located less precisely while maintaining the ideal zero clearance condition to the back of the chain. This is accomplished by allowing the chain to move the contact surface easily as the chain increases tension. This feature reduces costs by increasing mounting hole location tolerances and by eliminating the adjustment operation during its incorporation into the chain system. The completely elastomeric design also absorbs more of the vibrations created by the chain system than a prior art snubber, thus improving the noise-vibration-harshness (NVH) performance of the chain system. An elastomer or an elastomeric material is defined herein as a polymeric material having elastic properties such that it stretches rapidly under tensile stress with a high tensile strength and modulus when stretched and retracts rapidly to recover its original dimensions upon release of the stress.

A snubber preferably contacts the outside surface of the chain, or what is commonly referred to as the back of the chain. The snubber is unable directly to restrict the motion of the chain in the opposite direction. The snubber could be mounted inside the chain in which case it would contact the inside of the chain and restrict chain motion in that direction. However, since the teeth on the silent chain would contact the elastomeric material, wear of the snubber material would typically increase. For this reason, the snubber is usually mounted on the outside of the chain.

The design of the present invention isolates the snubber from the application's case better than the metal bracket of prior art snubber technology. The loss modulus of the elastomeric material is greater than that of the aluminum of which the metal bracket is usually made, therefore, a smaller portion of the total energy entering a snubber of the present invention actually gets transmitted to the case. The remaining portion of the total energy manifests itself as heat and dissipates back into the application. The compliant feature of the snubber also absorbs some energy. The compliant face, having a spring rate, requires some energy to move, resulting in less energy being available to be transmitted through the snubber body and into the application case.

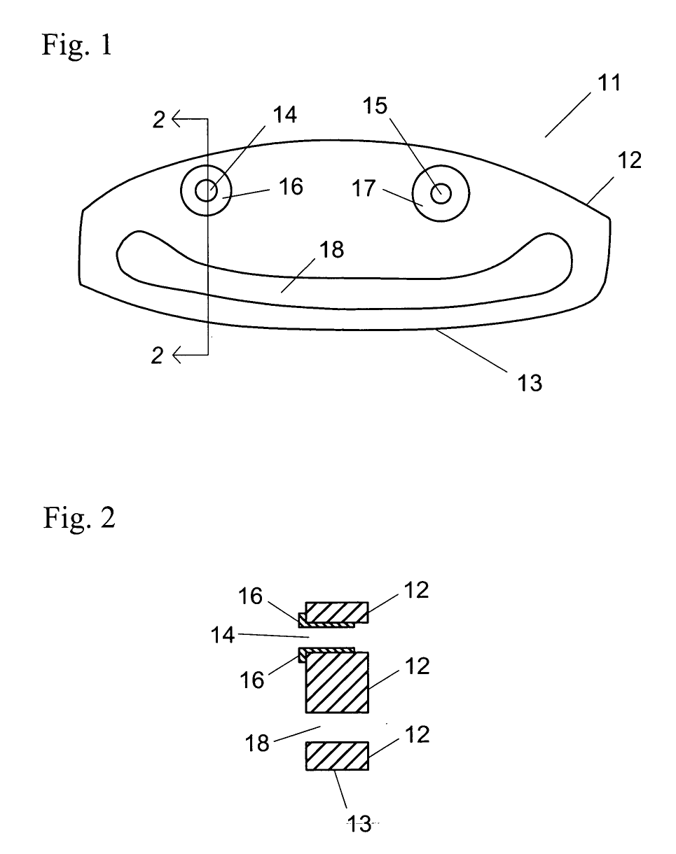

Referring to FIG. 1, a compliant snubber of the present invention (11) has a snubber body (12) with a snubber contact surface (13) for contacting a chain. In FIG. 1, the snubber is mounted through mounting holes (14) and (15) with bushings (16) and (17). The compliant snubber has a compliance cavity (18) located behind the contact surface (13). Although the snubber is shown as mounted through mounting holes (14) and (15) in the Figures, alternative mounting mechanisms are possible for any of the embodiments of the present invention. For example, the snubber can have features molded into it that connect to similar features (dovetails, etc.) in the application case, such as with a bracketless snubber. This feature eliminates the need for mounting hardware such as screws.

The snubber body is preferably made of an elastomeric material. Any material having a loss modulus similar to those elastomer polymers used in vibration dampening devices is preferred for the snubber body (12). These include, but are not limited to acrylonitrile butadienes (Nitrile or NBR), hydrogenated nitrites (HNBR), and ethylene acrylate copolymers (EAR). A preferred material for the snubber contact surface (13) is carboxylated nitrile (COX-NBR) due to its improved wear resistance over the NBR material.

The use of other elastomeric polymers, such as Butyl (natural rubber), is also possible. However, one of the limiting factors in choosing the material is the material's ability to function in a high temperature, oily environment. Another property of the snubber material that is critical is its wear resistance when running against the chain. The surface of the links contacting the snubber material can erode the snubber material which changes the clearance between the chain and the snubber, and results in degraded performance of the snubber in controlling the chain motion.

The contact surface (13) is compliant and moves with an applied force from the chain. The compliant surface allows more tolerance during assembly and allows the snubber to have a negative clearance to the chain back. The snubber compliance is designed to be stiff enough to resist chain resonance but compliant enough to minimize force at the contact surface. In this embodiment, compliance is controlled by the stiffness of the material of the body (12) and the size and shape of a compliance cavity (18) located behind the contact surface (13) of the snubber (11).

With any material, the force required to displace the contact surface (13) of the snubber changes with snubber geometry. For example, when the contact surface (13) is made thinner, the resulting deflection is concentrated in that thinner region. If the ends of the snubber are thinned more so than the snubber surface (13), the deflection is directed away from a specific area of the contact surface (13) and towards the ends of the snubber, resulting in the movement of the entire snubber contact surface (13). Both of these designs potentially have different spring rates, or deflection-versus-force performance characteristics. Likewise, for any given geometry, the deflection-versus-performance characteristics are altered by changing the material stiffness properties.

The shape of the cavity (18) is important in many ways. The cavity height determines the amount of compliance built into the design. It also directly affects the lateral chain motion allowed by the design. The shape at the ends of the cavity affects stress distribution and is preferably optimized to maximize fatigue life. The overall shape of the cavity affects the spring rate and the location of the deformation. This impacts how well the snubber dampens the chain strand resonance and how much of the contact surface of the snubber stays in contact with the back of the chain. The cavity is preferably oblong in shape. Oblong is hereby defined herein as having an elongated shape such that one dimension is significantly longer than a second dimension.

In another embodiment, the cavity is filled with a low spring rate material. Low durometer elastomers, such as the materials like the gels found in sports shoes or foam are preferred. The material must be compatible with the high temperatures and oil used in these applications. Other fillers, such as metal or plastic backers, can also be used to increase the contact surface spring rate.

One material preferably used to fill the cavity is Dupont Hytrel®, a thermoplastic polyester elastomer. This material offers good chemical and temperature resistance and can be injection-molded into the snubber cavity. It is available in a range of hardnesses such that a low stiffness grade can be used to absorb energy in the snubber cavity.

Referring to FIG. 2, a cross section of the compliant snubber of FIG. 1 along line 2-2 is shown. A bushing (16) inserts into the mounting hole (14) of the snubber body (12) for mounting of the snubber. A cross section of the compliance cavity (18) is also visible.

In another embodiment of the present invention, the snubber has a thin metal leaf spring inside of the compliance cavity to support the contact surface, which reduces weight, improves packaging, and also improves the durability and contact surface shape retention of the snubber. Other materials such as plastic can also be used to support the contact surface. Other types of springs can alternatively be used. For example, coil springs can be used to provide localized support, whereas the leaf spring supports a much larger area.

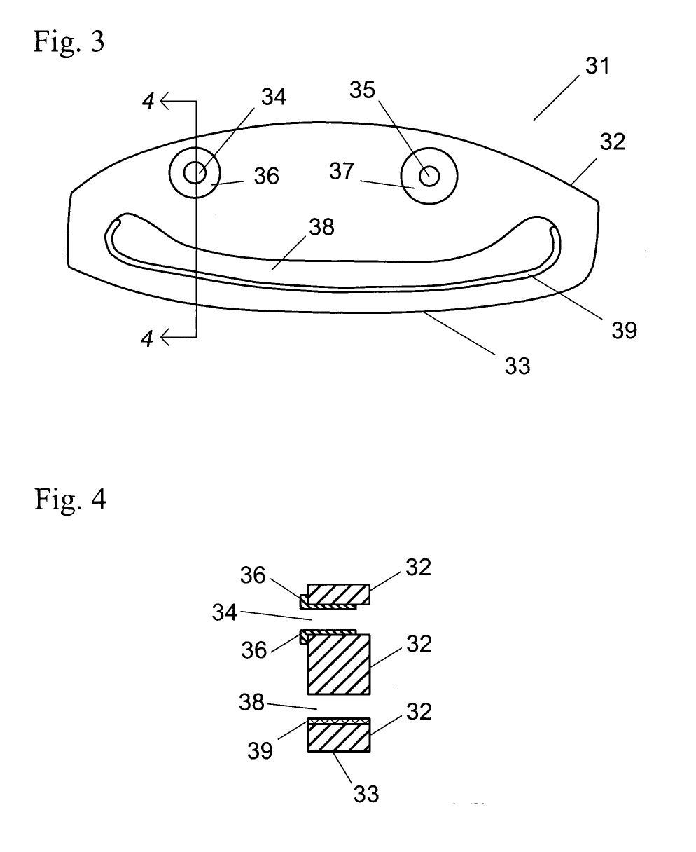

Referring to FIG. 3, a compliant snubber of the present invention (31) has a snubber body (32) with a snubber contact surface (33) for contacting a chain. In FIG. 3, the snubber is mounted through mounting holes (34) and (35) with bushings (36) and (37). The compliant snubber has a compliance cavity (38) located behind the contact surface (33). The contact surface (33) is compliant and moves with an applied force from the chain. The compliant surface allows more tolerance during assembly and allows the snubber to have a negative clearance to the chain back. The snubber compliance is designed to be stiff enough to resist chain resonance but compliant enough to minimize force at the contact surface. In this embodiment, compliance is controlled by the stiffness of the material of the body (32), the size and shape of the compliance cavity (38), and a leaf spring (39) located behind the contact surface (33) of the snubber (31).

Referring to FIG. 4, a cross section of the compliant snubber of FIG. 3 along line 4-4 is shown. A bushing (36) inserts into the mounting hole (34) of the snubber body (32) for mounting of the snubber. A cross section of the compliance cavity (38) and the leaf spring (39) within the compliance cavity are also visible.

In yet another embodiment of the present invention, the snubber is made of two different elastomers, each having a different durometric value, or stiffness.

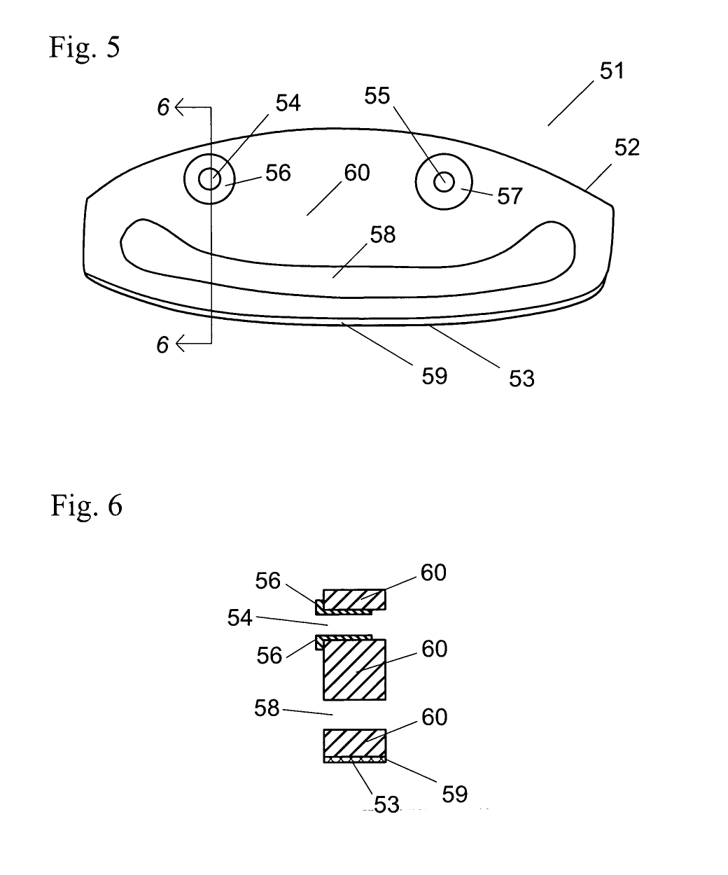

Referring to FIG. 5, a compliant snubber of the present invention (51) has a snubber body (52) with a snubber contact surface (53) for contacting a chain. In FIG. 5, the snubber is mounted through mounting holes (54) and (55) with bushings (56) and (57). The compliant snubber has a compliance cavity (58) located behind the contact surface (53). The contact surface (53) is compliant and moves with an applied force from the chain. In this embodiment, the snubber is made of two elastomeric materials. The compliant surface allows more tolerance during assembly and allows the snubber to have a negative clearance to the chain back. The snubber has a strip of a first elastomeric material (59) along the snubber contact surface (53). The snubber has a second elastomeric material (60) with a lower hardness than the first material for the remainder of the snubber body. The snubber compliance is designed to be stiff enough to resist chain resonance but compliant enough to minimize force at the contact surface. In this embodiment, compliance is controlled by the stiffness of the material (60) of the body (52), the size and shape of a compliance cavity (58), and the thickness and stiffness of the material (59) of the contact surface (53) of the snubber (51).

The material properties of the snubber body are preferably such that the dampening effect is maximized and wear resistance is of less significance. Therefore, the loss modulus should be high. Materials for the snubber body in this embodiment include, but are not limited to, low durometer nitrites and the EAR material. The contact surface material properties should be such that wear resistance is given high priority and the dampening characteristics are less important. Materials for the contact surface in this embodiment include, but are not limited to, higher durometer NBR's and HNBR's, and COX-NBR's.

The stiffnesses of the materials are selected such that the contact surface offers wear resistance, typical of higher stiffness materials, and the body of the snubber has high energy absorption, typical of lower stiffness materials. In a preferred embodiment, the high stiffness elastomer extends up to 50% of the contact surface thickness.

Referring to FIG. 6, a cross section of the compliant snubber of FIG. 5 along line 6-6 is shown. A bushing (61) inserts into the mounting hole (54) of the snubber body (52) for mounting of the snubber. A cross section of the compliance cavity (58) and the first elastomeric material (56) are also visible.

Another embodiment of the present invention includes a leaf spring and a snubber body including two different elastomers with different stiffnesses. The snubber has a strip of the first elastomeric material along the snubber contact surface. The snubber has a second elastomeric material with a lower hardness than the first material for the remainder of the snubber body.

In a preferred embodiment, the cavity has features, which look like offset teeth, added to it. These features are used to design a variable spring rate into the compliance feature. The teeth come into contact with each other as the snubber is compressed. In one embodiment the teeth have straight sides and come to a point. In another embodiment, the teeth have a convex curved surface. The teeth deflect as more force is applied, however, at a rate different from the initial rate.

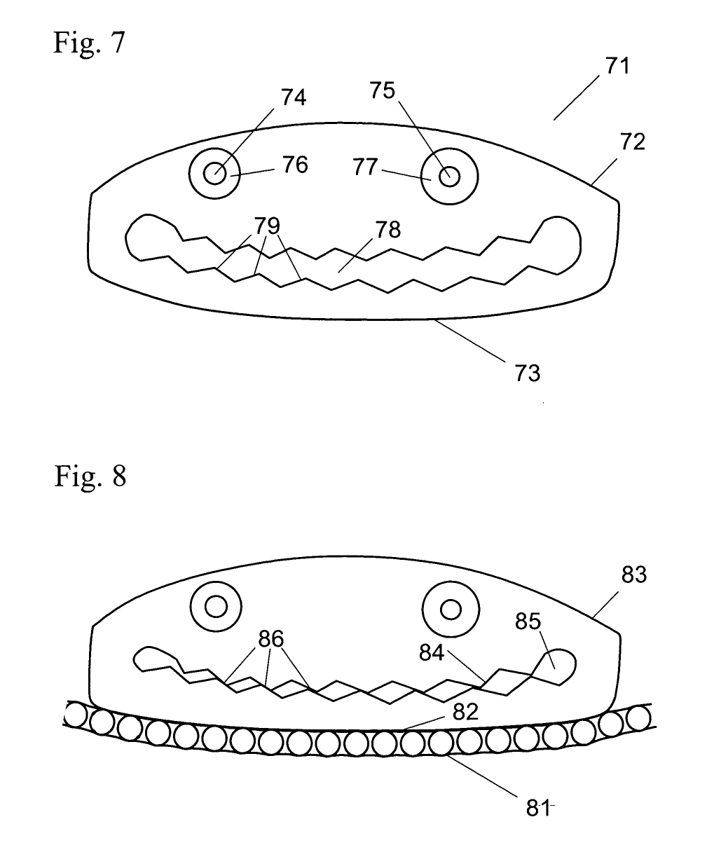

Referring to FIG. 7, a preferred embodiment with teeth is shown. In this embodiment, the compliant snubber (71) has a snubber body (72) with a snubber contact surface (73) for contacting a chain. In FIG. 7, the snubber is mounted through mounting holes (74) and (75) with bushings (76) and (77). The compliant snubber has a compliance cavity (78) located behind the contact surface (73). The contact surface (73) is compliant and moves with an applied force from the chain. The compliance cavity (78) has teeth (79), which deflect upon compression of the compliance cavity. The compliant surface allows more tolerance during assembly and allows the snubber to have a negative clearance to the chain back. The snubber compliance is designed to be stiff enough to resist chain resonance but compliant enough to minimize force at the contact surface. In this embodiment, compliance is controlled by the stiffness of the material of the body (72), the size and shape of a compliance cavity (78), and the size, shape, location, and number of teeth (79) in the compliance cavity.

Referring to FIG. 8, a portion of a chain (81) is shown contacting the contact surface (82) of a snubber (83) having teeth (84) extending into the compliance cavity (85). Tension in the chain has caused the snubber to deform such that the curvature of the contact surface is reduced. The compliance cavity has become compacted such that the upper and lower rows of teeth form points of contact (86). As the pressure on the contact surface increases beyond the point shown in FIG. 8, the two rows of teeth begin to interact, and the top row of teeth increasingly support the bottom row and resist deformation of the contact surface. Thus the tooth feature provides a gradually increasing spring rate to the snubber as the pressure from the chain deforms the compliance cavity past the point of tooth-tooth contact, such that the snubber has a variable spring rate.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A compliant snubber for a chain comprising a snubber body having:
a convex contact surface for contacting the chain; and
a compliance cavity located adjacent to the convex contact surface and extending through the snubber body, such that the contact surface is deflected toward the compliance cavity when a force is applied by the chain.

2. The snubber of claim 1, wherein the compliance cavity is oblong in shape.

3. The snubber of claim 1 further comprising a leaf spring located in the compliance cavity and exerting a force in a direction of the contact surface.

4. The snubber of claim 1, wherein the snubber body is made of an elastomer.

5. The snubber of claim 1, wherein the snubber body is made of a first elastomer and the contact surface is made of a second elastomer.

6. The snubber of claim 5, wherein the second elastomer is harder than the first elastomer.

7. The snubber of claim 1, wherein the snubber further comprises a mounting feature for mounting the snubber to an application case.

8. The snubber of claim 7, wherein the mounting feature comprises at least two holes through the snubber body, wherein the compliance cavity is located between the holes and the contact surface.

9. The snubber of claim 1, wherein the snubber body is made of a first material and the compliance cavity is filled with a second material having a lower spring rate than the first material.

10. The snubber of claim 1, wherein the snubber further comprises a plurality of opposing teeth extending from the snubber body into the compliance cavity.

11. The snubber of claim 10, wherein the teeth are formed along the length of the compliance cavity and the teeth are offset such that the snubber has a variable spring rate.
